(19) United States
(12) Patent Application Publication
(10) Pub. No.: US 2026/0257622 A1
(43) Pub. Date: Sep. 3, 2026

(54) CAMERA MONITOR SYSTEM WITH TRAILER REVERSE PARK ASSIST HAVING GRAPHICAL OVERLAY

(71) Applicant: STONERIDGE ELECTRONICS AB, Solna (SE)

(72) Inventors: Gabriel Lepage, Royal Oak, MI (US); Troy Otis Cooprider, White Lake, MI (US)

(21) Appl. No.: 19/158,110

(22) PCT Filed: Mar. 6, 2024
(86) PCT No.: PCT/EP2024/055913

§ 371 Date: Aug. 20, 2025

Related U.S. Application Data
(60) Provisional application No. 63/450,692, filed on Mar. 8, 2023.

(51) Int. Cl. B60R 1/25; B60R 1/26; H04N 23/90

(52) U.S. Cl. CPC B60R 1/25; B60R 1/26; B60R 2300/105; B60R 2300/20; B60R 2300/308; B60R 2300/8046; H04N 23/90

(57) ABSTRACT

A camera monitor system (CMS) includes multiple cameras that include first and second cameras that provide first and second fields of view. At least one sensor provides a third field of view aft of a trailer end of the trailer to detect at least one object in proximity to the trailer end. Multiple displays include first and second displays that depict at least portions of the first and second fields of view. One of the multiple displays depicts the third field of view provided by at least a graphical overlay. A controller in communication with the multiple displays determines a distance of the trailer end from the object, and the distance is displayed on the one of the multiple displays as at least a portion of the graphical overlay.

### CROSS-REFERENCE TO RELATED APPLICATION

The present disclosure claims priority to U.S. Provisional Patent Application No. 63/450,692 filed Mar. 8, 2023.

### TECHNICAL FIELD

This disclosure relates to a camera monitor system (CMS) for use in a commercial truck or similar vehicle, and, in particular, to a CMS having a display with a trailer reverse park assist graphical overlay.

### BACKGROUND

Mirror replacement systems, and camera systems for supplementing mirror views, are utilized in commercial vehicles to enhance the ability of a vehicle operator to see a surrounding environment. Camera monitor systems (CMS) utilize one or more cameras to provide an enhanced field of view to a vehicle operator. In some examples, the CMS covers a larger field of view than a conventional mirror, or include views that are not fully obtainable via a conventional mirror.

In a typical CMS, there is a camera arm arranged on each of the left- and right-hand sides of the vehicle to provide Class II and Class IV views. A display is provided on or near the A-pillar on both driver and passenger sides to display the field of view for the camera arm on that side, simulating a conventional mirror.

It is desirable for a driver to have visibility immediately behind a tractor-pulled trailer, which may be 53 feet in the United States. A typical Class II and Class IV view does not provide such a view, as it can only provide views alongside the trailer. Reverse maneuvers, such as docking, may be particularly difficult.

### SUMMARY

In one exemplary embodiment, a camera monitor system (CMS) for a tractor with a trailer, the CMS includes multiple cameras that include first and second cameras that are respectively configured to provide first and second fields of view, the first field of view along one side of the trailer, and the second field of view along another side of the trailer. At least one sensor is configured to provide a third field of view aft of a trailer end of the trailer. The at least one sensor is configured to detect at least one object in proximity to the trailer end. Multiple displays include first and second displays that are configured to respectively depict at least portions of the first and second fields of view. One of the multiple displays are configured to depict the third field of view provided by at least a graphical overlay. A controller is in communication with the multiple displays. The controller is configured to determine a distance of the trailer end from the object. The distance is displayed on the one of the multiple displays as at least a portion of the graphical overlay.

In a further embodiment of any of the above, the first and second fields of view respectively capture left and right sides of a vehicle. Each of the first and second fields of view include at least a portion of Class II and/or Class IV views.

In a further embodiment of any of the above, the one of multiple displays is different than the first and second displays.

In a further embodiment of any of the above, the at least one sensor includes a trailer camera that is configured to provide the third field of view directly and centrally aft of the trailer end.

In a further embodiment of any of the above, the distance corresponds to an estimated distance from a trailer deck at the trailer end.

In a further embodiment of any of the above, the at least one sensor includes an inclination sensor. The distance is an estimated distance of a roof of the trailer end overhanging the trailer deck in a horizontal plane.

In a further embodiment of any of the above, the object is a trailer door at the trailer end, and the at least one sensor is configured to detect the trailer door in an open position. The distance corresponds to an estimated distance of the trailer door from a side wall of the trailer.

In a further embodiment of any of the above, the at least one sensor includes a door switch.

In a further embodiment of any of the above, the at least one sensor includes at least one of the first and second cameras.

In a further embodiment of any of the above, the object corresponds to trailer side walls at the trailer end, and the distance corresponds to an estimated location of the trailer side walls.

In another exemplary embodiment, a method of displaying information during a trailer reversing maneuver, the method includes detecting an object in proximity to a trailer end of a trailer, and determining a distance of the object from the trailer end. The distance corresponds to at least one of an estimated distance from a trailer deck at the trailer end, an estimated distance of a roof of the trailer end from the trailer deck in a horizontal plane, an estimated distance of the trailer door from a side wall of the trailer, an estimated location of trailer side walls, and displaying a distance line related to the distance.

In a further embodiment of any of the above, the method includes a step of displaying first and second fields of view that respectively correspond to left and right sides of a vehicle. Each of the first and second fields of view include at least a portion of Class II and/or Class IV views.

In a further embodiment of any of the above, the distance line displaying step is performed on one display, and the first and second fields of view displaying step is performed on other displays.

In a further embodiment of any of the above, the detecting step is performed by capturing an image directly and centrally aft of the trailer end.

In a further embodiment of any of the above, the distance corresponds to an estimated distance from a trailer deck at the trailer end.

In a further embodiment of any of the above, the distance corresponds to an estimated distance of a roof of the trailer end from the trailer deck in a horizontal plane.

In a further embodiment of any of the above, the distance corresponds to an estimated distance of the trailer door from a side wall of the trailer.

In a further embodiment of any of the above, the detecting step includes sensing whether a door is open with a door switch.

In a further embodiment of any of the above, the detecting step includes capturing images of the side wall with a camera that is mounted on a tractor that is configured to pull the trailer.

In a further embodiment of any of the above, the distance corresponds to an estimated location of trailer side walls.

### BRIEF DESCRIPTION OF THE DRAWINGS

The disclosure can be further understood by reference to the following detailed description when considered in connection with the accompanying drawings wherein:

FIG. 1A is a schematic front view of a commercial truck with a camera monitor system (CMS) used to provide at least Class II and Class IV views.

FIG. 1B is a schematic top view of a commercial truck with a camera monitor system providing Class II, Class IV, Class V, Class VI and Class VIII views.

FIG. 2 is a schematic view of a vehicle cabin with a CMS including various displays, cameras and inputs.

FIG. 3 illustrates a typical docking maneuver with a trailer.

FIG. 4 is a method of displaying information during a trailer reversing maneuver.

FIG. 5 illustrates a display providing a graphical overlay during the trailer reversing maneuver.

FIG. 6 illustrates another example display providing another graphical overlay during the trailer reversing maneuver.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

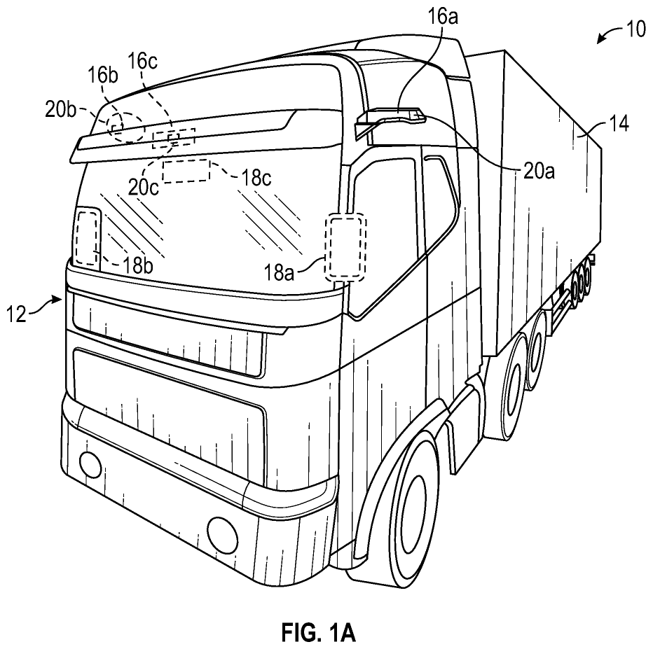

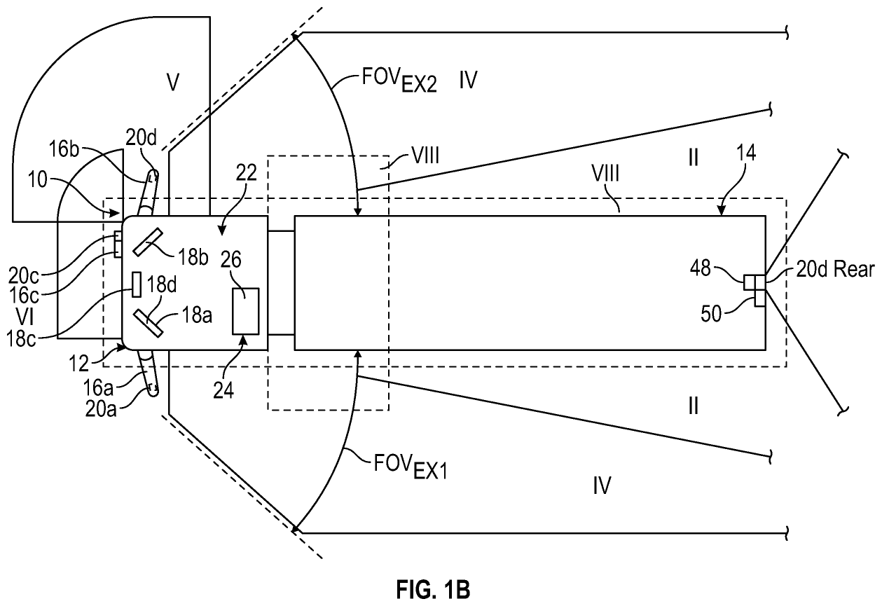

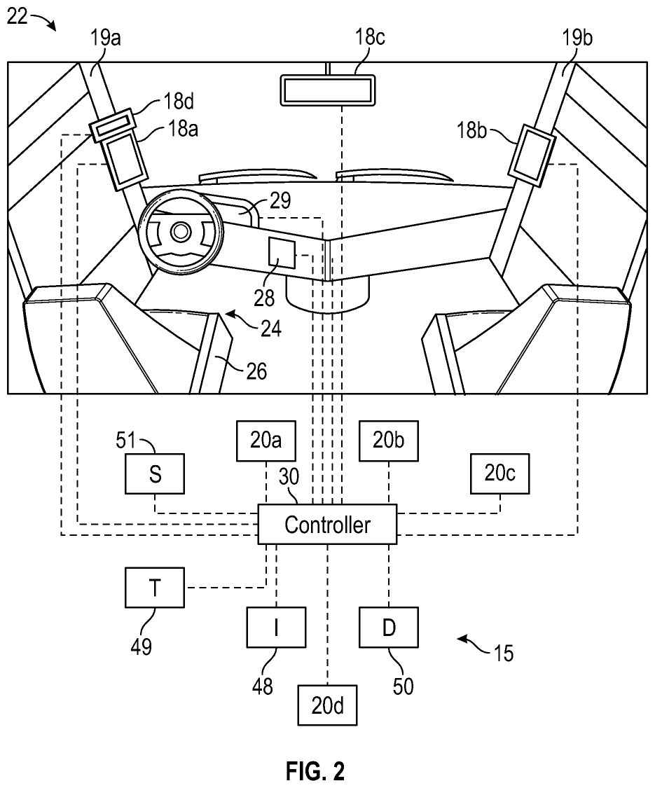

A schematic view of a commercial vehicle 10 is illustrated in FIGS. 1A and 1B. The vehicle 10 includes a vehicle cab or tractor 12 for pulling a trailer 14. It should be understood that the vehicle cab 12 and/or trailer 14 may be any configuration. Although a commercial truck is contemplated in this disclosure, the invention may also be applied to other types of vehicles. The vehicle 10 incorporates a camera monitor system (CMS) 15 (FIG. 2) that has driver and passenger side camera arms 16a, 16b mounted to the outside of the vehicle cab 12. If desired, the camera arms 16a, 16b may include conventional mirrors integrated with them as well, although the CMS 15 can be used in some examples to entirely replace mirrors. In additional examples, each side can include multiple camera arms, each arm housing one or more cameras and/or mirrors.

Each of the camera arms 16a, 16b includes a base that is secured to, for example, the cab 12. A pivoting arm is supported by the base and may articulate relative thereto. At least one rearward facing camera 20a, 20b is arranged respectively within camera arms 16a, 16b. Each arm 16a, 16b may also provide a housing that encloses electronics, e.g., a controller, that are configured to provide various features of the CMS 15.

The exterior cameras 20a, 20b respectively provide an exterior field of view FOV_{EX1}, FOV_{EX2} that each include at least one of the Class II and Class IV views (FIG. 1B), which are legally prescribed views in the commercial trucking industry. The Class II view on a given side of the vehicle 10 is a subset of the class IV view of the same side of the vehicle 10. Multiple cameras also may be used in each camera arm 16a, 16b to provide these views, if desired. Class II and Class IV views are defined in European R46 legislation, for example, and the United States and other countries have similar drive visibility requirements for commercial trucks. Any reference to a “Class” view is not intended to be limiting, but is intended as exemplary for the type of view provided to a display by a particular camera.

First and second video displays 18a, 18b are arranged on each of the driver and passenger sides within the vehicle cab 12 on or near the A-pillars 19a, 19b (generally, A-pillar 19; FIG. 2) to display Class II and Class IV views on its respective side of the vehicle 10, which provide rear facing side views along the vehicle 10 that are captured by the exterior cameras 20a, 20b.

If video of Class V and/or Class VI views are also desired, a camera housing 16c and camera 20c may be arranged at or near the front of the vehicle 10 to provide those views (FIG. 1B). A third display 18c arranged within the cab 12 (FIG. 2) near the top center, left or right of the windshield can be used to display the Class V and Class VI views, which are toward the front of the vehicle 10, to the driver.

Alternatively or additionally, other displays can be added near the first, second and third displays 18a, 18b, 18c and provide a display dedicated to providing a Class VIII view. If video of Class VIII views is desired, camera housings can be disposed at the sides and/or rear of the vehicle 10 to provide fields of view including some or all of the Class VIII zones of the vehicle 10. In such examples, a fourth display 18d, either separate or integrated into another display, can include one or more frames displaying the Class VIII views.

The displays 18a, 18b, 18c, 18d (generally, display 18) face a driver region 24 within the cabin 22 where an operator is seated on a driver seat 26. The location, size and field(s) of view streamed to any particular display may vary from the configurations described in this disclosure and still incorporate the disclosed invention.

Referring to FIG. 2, each display 18a, 18b (and perhaps others, if desired) the display 18 is mounted to its respective A-pillar 19 by a bracket, for example, or integrated into vehicle trim. The display 18 may include any suitable screen such as TFT, LCD, LED, OLED and others. Each type of screen typically employs some approach for adjusting perceived brightness.

Example rear view display configurations are described in U.S. Provisional Patent Application No. 63/430,701, entitled “TRAILER CAMERA DISPLAY SYSTEM”, filed on Dec. 7, 2022, which is incorporated herewith in its entirety. In one example the rear view display 18d is positioned proximate a corresponding side view display 18a or 18b (e.g., a class II/IV view display) at or near its respective A-pillar.

One example vehicle cabin 22 is schematically shown in FIG. 2. The cabin 22 includes an instrument cluster display 29 that typically operates to display vehicle information such as speed, engine RPM, and other common vehicle and/or engine operating parameters. The example vehicle also includes a center console display 28 and the camera monitoring system (CMS) displays 18a, 18b positioned on each of the A-19a, 19b, respectively. A Class V/Class VI display 18c also may be arranged near the top of the windshield.

In the example also mounted on one of the A-pillars (e.g, 19a, located by driver) is the rearview display 18d. The rearview display 18d is configured to replace a traditional rearview mirror for vehicles where the rearview mirror is not always functional, such as vehicles for pulling a trailer. In other examples (not shown), a second rearview display can be positioned on the passenger side A-pillar 19b. In alternative examples, another rearview monitor can be positioned in the traditional location (at or near display 18c) in addition to the rearview display 18d positioned on the A-pillar 19a. In each of the alternate examples, all rearview displays may depict the same view.

By mounting the rearview display 18d adjacent the display 18a and the A-pillar 19a, the rearview display 18d is maintained within the peripheral vision of the vehicle operator during all vehicle operations, and the operator is not required to alter their gaze to check the rearview, as would be required for a traditional rearview mirror location. In the examples where the redundant monitors are utilized at additional locations, like at passenger side A-pillar 19b and in the mid-top of the windshield, further ensures that a rearview is presented to the vehicle operator at all times during operation, regardless of which direction the operator has shifted their gaze.

The rearview display 18d may be contained within the same display housing as the corresponding displays 18a, 18b and/or 18c. In alternative constructions, the rearview display 18d may be contained within distinct housings, and the housings for the rearview display 18d are positioned proximate to one of the corresponding housings of displays 18a, 18b and/or 18c.

With continuing reference to FIG. 2, the CMS 15 includes a controller 30 in communication with, for example, the displays 18a, 18b, 18c, 18d, 28, 29; the cameras 20a, 20b, 20c, 20d; and various inputs 48-51. Example inputs include but are not limited to an inclination sensor 48, a transmission sensor 49, a trailer door switch 50, and a vehicle speed sensor 51. The controller 30 may access the inputs over a CAN bus, a LIN bus or other communications configuration.

Inputs and/or sensors located on the trailer 14 (e.g., rearview camera 20d, inclination sensor 48 and/or trailer door switch 50) may be broadcast over a trailer wiring harness according to International Patent Application No. PCT/US22/34710, entitled “TRAILER CAMERA COMMUNICATIONS SYSTEM”, filed on Jun. 23, 2022 and incorporated herewith in its entirety.

As described above, the controller 30 (“controller” may generally be referenced as “30”) is in communication with the first and second displays 18a, 18b. It should be noted that the described controller 30 can be used to implement the various functionality disclosed in this application. The controller 30 may include one or more discrete units.

In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller 30 may be a hardware device for executing software, particularly software stored in memory. The controller 30 can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller 30 is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

This disclosure relates to a CMS and a method for providing a graphical overlay used for rearview camera applications, which arise during various vehicle trailer reversing maneuvers. The primary purpose of the graphical overlay is to provide a visual aide to a driver to localize the position of a trailer and other surrounding objects during reversing operations. The differentiation of this graphical overlay from others used for similar purposes is the addition of a visual representation of the trailer edges, approximate location of the trailer doors (when open) and finally an extra indication of the trailer top edge in case the trailer is inclined with respect to the mating dock to prevent trailer collision. The disclosed CMS 15 may provide some or all of the above functionality.

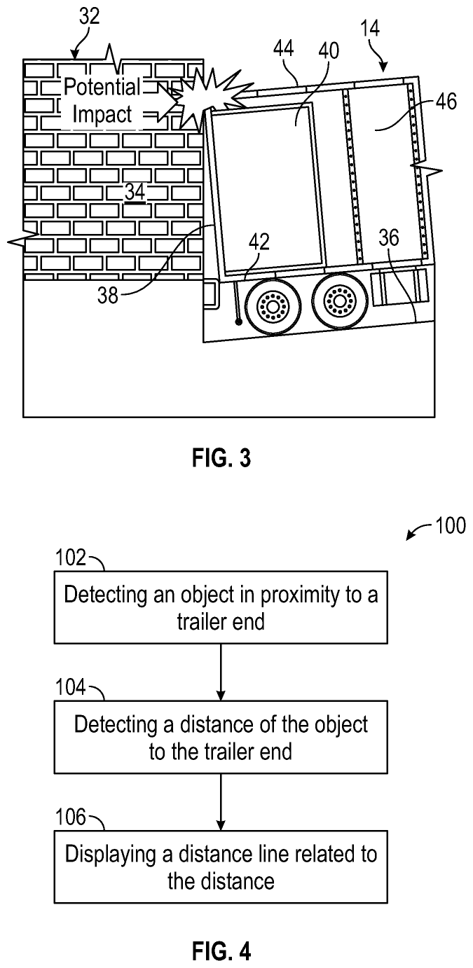

FIG. 3 illustrates a common example reversing maneuver, docking. During a typical docking maneuver the vehicle 10 reverses such that a trailer end 38 approaches a cargo bay 34 of a building 32 for loading and unloading of cargo. Often the trailer 14 travels down a ramp 36 toward the building 32 to place the deck 42 of the trailer 14 level with the floor of the cargo bay 34.

For an enclosed trailer 14 with a roof 44 and sidewalls 46, the doors 40 on the trailer 14 typically must be opened prior to the vehicle 10 backing up to the cargo bay 34. This is normally necessary because of special constraints that prevent the doors from swinging open into the cargo bay 34 and/or outward and alongside the sidewalls 46. That is, the cargo bay 34 door is about the size of the opening in the back of the trailer 14, and the trailer 14 is often very close to other vehicles or structures on either side of the trailer during docking and parking maneuvers.

The disclosed CMS 15 and method 100 (FIG. 4) provide visibility to the driver during reversing maneuver and communicate useful information to the driver during these operations in a way that prevents unwanted collisions between the trailer 14 and surrounding objects.

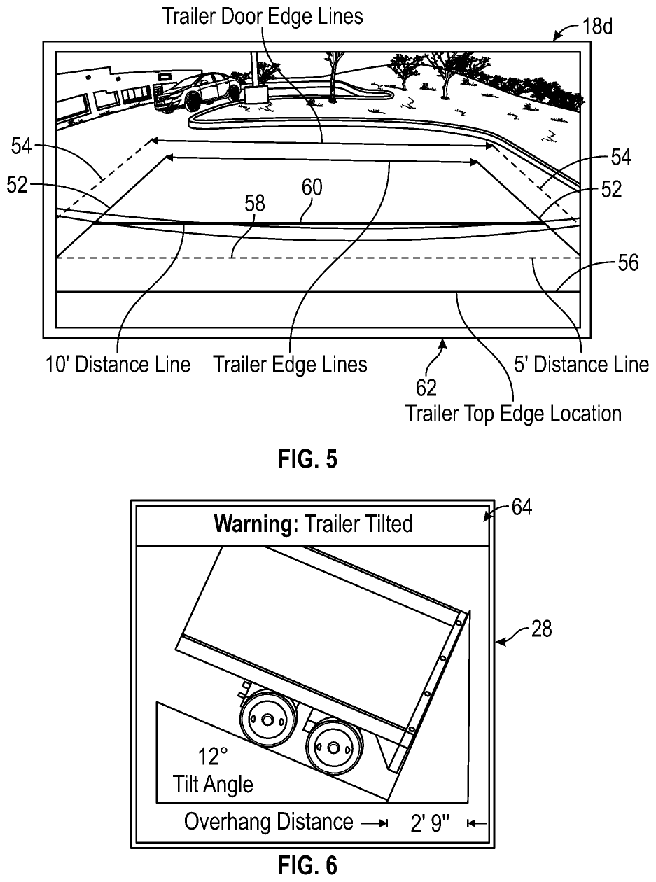

The CMS 15 performs the method 100 shown in FIG. 4 by detecting an object in proximity to the trailer end 38 (block 102). The object may include the building 32, doors 40 of the trailer 14, or other objects in proximity to the trailer end 38. The controller 30 determines at least one distance from the object to the trailer end 38 (block 104). The estimated distance is displayed as distance or awareness lines graphically overlayed onto the rearview display 18d to graphically illustrate to the driver the distance of the object from the trailer end 38 (block 106). Example reversing maneuvers using this method are described further below, and examples of the associated graphical overlays is shown in FIG. 5. The graphical overlays are superimposed over the image provided by the rearview camera 20d on the rearview display, although annotations like those shown in FIG. 5 may be omitted. Instead different colors may be used for quick identification by the driver.

### Example 1: Reversing Maneuvers (Trailer Width)

The rearview camera 20d, for example, which captures images directly and centrally aft of the trailer end, is used to determine the location of the estimated distance of the trailer sidewall edge of the sidewalls 46. The trailer sidewall edges are represented as a graphical overlay of trailer sidewall edge lines 52. Alternatively or additionally, the sideview cameras 20a, 20b and/or other sensors may be used to estimate the trailer sidewall edge. This information assists the driver to visualize the wide of the trailer 14 in relation to objects in the view of the rearview camera 20d during reversing maneuvers, such as docking.

### Example 2: Reversing (Trailer Doors Open)

Having the trailer doors 40 open when reversing, which is a common occurrence, results in a wider overall trailer width. This can be problematic during reversing maneuvers such as docking and parking. Thus, it is desirable to estimate the distance of each trailer door 40 from the sidewalls 46 of the trailer 14.

A sensor or switch 50, such as a momentary switch, can be used to determine whether the doors 40 are open. One switch 50 may be provided for each door 40, if desired. The door open condition can be verified by the sideview cameras 20a, 20b, or these camera may be used instead of the switch 50. A trailer door edge line 54 is graphically overlayed onto the image displayed in the rearview display 18d. The displayed lines correspond to an estimated distance of each trailer door 40 from each sidewall 46. In the case of switch 50 with no verification or estimation, the trailer door edge lines 54 are displayed at a standard offset from the trailer width (e.g., offset from the trailer sidewall edge lines 52). It should be understood that only one of the trailer sidewall edge lines 52 or the trailer door edge lines 54 may be shown, if desired. If the sideview cameras 20a, 20b are used, the actual location of the doors 40 may be used graphically overlaying the trailer door edge lines 54. This can be done dynamically to change the trailer door edge lines 54 if the doors 40 become detached and are unaffixed relative to the sidewalls 46 to which they are typically attached.

### Example 3: Docking at a Building (Trailer Tilt/Trailer Roof Overhang)

An inclination sensor 48, such as an accelerometer, may be used to determine the tilt angle of the trailer 14. The tilt angle during docking is generally such that the edge of the roof 44 overhangs the deck, as the ramp 36 to the building 32 is typically pitched downward. As a result, the roof 44 may collide with the building 32 before the deck 42 can abut the floor of the cargo bay 34. To this end, a trailer top edge is determined. In one example, the controller 30 may calculate the overhang (distance of a roof 44 of the trailer end 38 from the trailer deck 42 in a horizontal plane) based upon the standard overall trailer height for the jurisdiction in which the trailer 14 is being used. In the United States, the standard overall trailer height is 13 feet, 6 inches (162 inches). An overhang equation is as follows:

$$Overhang Distance ( inches ) = 162 * sin ( tilt angle° ) . \qquad Equation 1$$

For a tilt angle of 12°, the overhang distance is 2 feet, 9 inches) (162*sin(12°=33 inches). Thus, a trailer top edge line 56 corresponding to 2 feet, 9 inches is graphically overlayed onto the image displayed on the rearview display 18d.

### Example 4: Docking at a Building (Distance From Trailer Deck)

Awareness lines, such as first and second distance lines 58, 60 may also be overlayed onto the image displayed on the rearview display 18d to visually indicate the distance of the trailer end 38 (deck 42 or roof 44) from the object (e.g., building 32). In one example, the first distance line corresponds to 5 feet, and the second distance line corresponds to 10 feet. These distances may be determined using a sensor such as rearview camera 20d, or other sensors such as ultrasonic, LiDAR, IR and/or PIR, for example. Although a sensor could be used to estimate distances from an object in real time, another example of the distance line placement is determined using camera pose with respect to the trailer rear face (camera depth offset from the trailer end/rear face) and ground (camera height to ground). Distance lines may be statically calibrated during installation using ground truth markers (calibration mat for overlay) or camera pose (position plus orientation) with respect to the trailer end/rear face and ground.

The above features may be used in conjunction with a trailer reversing path estimation algorithm. For example, the trailer edge lines in Examples 1 and 2 are useful during turning maneuvers while reversing. With the addition of a kinematic model for the trailer 14, the trailer edge lines could also respond to the calculated trailer trajectory and create an arc denoting the projected path similar to shown below (for a trailer reversing and turning left). One example algorithm is disclosed in United States Provisional Application No. 63/426,391, entitled “TRAILER BACKUP TRAJECTORY OVERLAY USING TRAILER CAMERA DISPLAY SYSTEM”, filed on Nov. 18, 2022, which is incorporated herein by reference in its entirety.

Any of the above graphical overlays may be used separately or in combination with one another or other graphical overlays. If an additional more prominent warning to the driver is desired, warning 64 may be depicted on one of the displays 28 or 29, for example, as shown in FIG. 6. The warning 64 can depict the tilt angle and overhang in bold colors and amount, if desired. Illustrating the warning 64 in this manner and on a display other than the rearview display 18d will not obstruct the rearview provided in the rearview display 18d. A small, unobtrusive warning 62 can be provided at the bottom of the rearview display 18d, for example, to communicate any desired warnings.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A camera monitor system (CMS) for a tractor with a trailer, the CMS comprising:
multiple cameras including first and second cameras respectively configured to provide first and second fields of view, the first field of view along one side of the trailer, and the second field of view along another side of the trailer;
at least one sensor configured to provide a third field of view aft of a trailer end of the trailer, the at least one sensor configured to detect at least one object in proximity to the trailer end;
multiple displays including first and second displays configured to respectively depict at least portions of the first and second fields of view, one of the multiple displays configured to depict the third field of view provided by at least a graphical overlay; and
a controller in communication with the multiple displays, the controller configured to determine an edge line of each trailer side wall relative to the trailer end, and the edge lines are displayed on the one of the multiple displays as at least a portion of the graphical overlay to illustrate an estimated location of the trailer side walls.

2. The CMS of claim 1, wherein the first and second fields of view respectively capture left and right sides of a vehicle, each of the first and second fields of view include at least a portion of Class II and/or Class IV views.

3. The CMS of claim 2, wherein the one of multiple displays is different than the first and second displays.

4. The CMS of claim 1, wherein the at least one sensor includes a trailer camera configured to provide the third field of view directly and centrally aft of the trailer end.

5. The CMS of claim 1, wherein the object is a trailer door at the trailer end, and the at least one sensor is configured to detect the trailer door in an open position, and the controller is configured to depict on the one of the multiple displays trailer door edge lines corresponding to the trailer doors relative to the trailer side walls.

6. The CMS of claim 5, wherein the at least one sensor includes a door switch.

7. The CMS of claim 5, wherein the at least one sensor includes at least one of the first and second cameras.

8. A method of displaying information during a trailer reversing maneuver, the method comprising:
detecting an object in proximity to a trailer end of a trailer;
determining a location of the object from the trailer end, wherein the location corresponds to
an estimated location of trailer side walls; and
displaying distance lines corresponding to the estimated location of the trailer side walls.

9. The method of claim 8, comprising a step of displaying first and second fields of view respectively corresponding to left and right sides of a vehicle, each of the first and second fields of view include at least a portion of Class II and/or Class IV views.

10. The method of claim 9, wherein the distance lines displaying step is performed on one display, and the first and second fields of view displaying step is performed on other displays.

11. The method of claim 8, wherein the detecting step is performed by capturing an image directly and centrally aft of the trailer end.

12. The method of claim 8, wherein the detecting step includes sensing whether a door is open with a door switch, and the displaying step includes depicting on trailer door edge lines corresponding to the trailer doors relative to the trailer side walls.
